(19) United States
(12) Patent Application Publication
(10) Pub. No.: US 2005/0189773 A1
(43) Pub. Date: Sep. 1, 2005

(54) Latch apparatus for blast-resistant container

(76) Inventors: Hsin-Yun Tsai, Hsinchu (TW); Ming-Jong Wang, Hsinchu (TW)

Correspondence Address: PRO-TECHTOR INTERNATIONAL SERVICES, 20775 Norada Court, Saratoga, CA, 95070-3018, US

(21) Appl. No.: 10/838,775

(22) Filed: May 3, 2004

(30) Foreign Application Priority Data
Feb. 13, 2004 (TW) 093103569

(51) Int. Cl. E05C 3/04

(52) U.S. Cl. 292/241; 220/324

(57) ABSTRACT

A latch apparatus for a blast-resistant container, comprising a chain hook on an edge of the container, a hook seat on a sliding door, a base, a connecting piece, a latch and a nut. The latch has a curved surface next to the hook seat and a front plate with a wedge-shaped cross-section. When the latch is turned into a locked state, the curved surface and front plate thereof push a hook on the chain hook tightly into the hook seat, so that in the locked state the chain hook will not loosen and will expose only a short lever arm, providing improved protection from a blast.

### FIELD OF THE INVENTION

The present invention relates to a latch apparatus for a blast-resistant container, particularly to a latch apparatus for a blast-resistant container having a latch with a curved surface and a wedge plate which during a locking process push a chain hook tightly into a seat, so that in a locked state the chain hook will not loosen and will expose only a short lever arm, providing improved protection from a blast.

### DESCRIPTION OF RELATED ART

As shown in FIG. 7, Chinese patent no. CN ZL02230761.3 discloses a strengthened door structure having four sides each being furnished with a hook A and a hook seat C on a sliding door plate B. During a closing movement of the sliding door towards a closing edge (right side in the Fig.), the hook seat C to the right on the sliding door plate B engages with a chain hook D. For convenience of engaging chain hook D and hook seat C, the chain hook D is given a generous angular range. To prevent the chain hook D from disengaging from the hook seat C, which would impair resistance against a blast, at least one latch secures the chain hook D in the engaged position thereof.

As shown in FIG. 8, the engagement structure cited above further has a clamp E attached to the sliding door plate B for preventing the chain hook D from disengaging from the hook seat C. However, this arrangement does not provide for a sufficiently precise movement of the chain hook, and a test of resistance against blasts requires a large amount of time for position checking.

Referring now to FIG. 9, Taiwan patent no. 171592 discloses a latch apparatus comprising a handle F mounted on a sliding door plate B, a latch G, and a supporting spring H, which after releasing the handle F drives automatic closing of the latch apparatus.

As shown in FIG. 10, Taiwan patent no. 197769 discloses a latch apparatus similar to the latch apparatus shown in FIG. 9, comprising a handle I and a latch J, but having a wave-shaped plate spring K substituted for the supporting spring for positioning the handle I.

To summarize, The latch apparatuses shown in FIGS. 8-10 provide only for blocking in a horizontal direction, preventing the chain hook D from disengaging from the hook seat C, but not for positioning of the chain hook D relative to the hook seat C. Usage and looks of these latch apparatuses are in need of improvement.

Above conventional latch apparatuses all do not allow to fix the relative positions of the chain hook D and the hook seat C, with a gap left in between. As shown in FIGS. 11A and 11B. When an explosion occurs in the container. The shock wave will indure extremely high membrane stress on the container structure instantly. If lever arms L1>L2 formed by the chain hook D and the hook seat C. Since the lever arms are relatively large, high bending stress and subsequent damage result, and resistance against blasts is lost.

### SUMMARY OF THE INVENTION

It is the object of the present invention to provide a latch apparatus for a blast-resistant container having a latch with a curved surface and a wedge plate which during a locking process push a chain hook tightly into a seat, so that in a locked state the chain hook will not loosen and will expose only a short lever arm, providing improved protection from a blast.

The present invention can be more fully understood by reference to the following description and accompanying drawings.

### DETAILED DESCRIPTION OF THE PREFERRED EMBODIMENTS

The latch apparatus for a blast-resistant container of the present invention comprises: a door plate 10 with a front side and a rear side; a base 20; a connecting piece 30; a latch 40; a nut 50; and a chain hook 60 fastened to an edge of a container. The base 20 and the connecting piece 30 together pass through the doorplate 10. The latch 40 is mounted on the connecting piece 30, performing a turning movement thereon. Further details will be explained below.

A hook seat 11 is fastend on the doorplate 10. The doorplate 10 has a through hole 12 surrounded by holes 13.

The base 20 comprises an axis 21 and a base plate 22 attached thereto. The base plate 22 is placed on the rear side of the door plate 10, with the axis 21 reaching through the through hole 12, having a far end with a thread 24 on the front side of the door plate 10. Positioning holes 23 on the base plate 22 surround the axis 21.

The connecting piece 30 comprises a tubelet 31 with a front end and a rear plate 33 attached to the tubelet 31 opposite to the front end thereof. The connecting piece 30 is put over the base 20, with the tubelet 31 surrounding the axis 21 and the rear plate 33 being set on the front side of the door plate 10. A step 32 is cut into the tubelet 31 near the front end thereof. The rear plate 33 has a rear side from which several pins 34 extend rearward.

The latch 40 at a central hole 41 thereof is set on the rear end of the tubelet 31 of the connecting piece 30. A handle 42 is integrated into the latch 40. Opposite to the handle 42 the latch has an engaging section with a curved surface 43. A wedge plate 44 with a wedge-shaped cross section is attached to the latch 40. The central hole 41 is surrounded by a circular depression 41a.

The nut 50 is screwed on the thread 24 of the axis 21 of the base 20.

The chain hook 60 is fastened to the container and is, as well as the hook seat 11, made using conventional art, which does not need to be explained further.

The present invention is assembled by first having the axis 21 of the base 20 pass through the through hole 12 of the door plate 10, so that the base plate 22 leans close to the door plate 10 at the rear side thereof. Then the tubelet 31 of the connecting piece 30 is put on the far end of the axis 21, with the pins 34 passing through the holes 13 in the door plate 10 and the positioning holes 23 of the base 20, preventing the connecting piece 30 from turning around the axis 21. After that, the latch 40 is at the central hole 41 thereof set on the tubelet 31 of the connecting piece 30, allowing the latch 40 to turn around the tubelet 31. Finally, the nut 50 is put on the far end of the axis 21 and screwed tight on the thread 24 thereof, preventing the latch 40 from separating from the connecting piece 30.

As shown in FIGS. 2A and 2B, in an open state, the latch 40 is placed to the left of the chain hook 60, with the curved surface 43 thereof leaning against a hook 61 of the chain hook 60. In this state, the hook 61 is not engaged with a groove 14 of the hook seat 11. Therefore, the doorplate 10 can be freely opened or closed using the handle 42.

Referring to FIGS. 2C and 2D, in a locked state, the handle 42 has been moved down, as indicated by the arrow, resulting in the curved surface 43 pushing the hook 61 of the chain hook 60 into the groove 14 of the hook seat 11. At the same time, the wedge plate 44, due to the shape thereof, pushes the hook 61 close to the hook seat 11, minimizing a resulting lever arm composed of the hook 61 and the hook seat 11 (see FIGS. 11A and 11B, L2<L1 ). Thus resistance against a blast is improved.

In the embodiment shown, the latch 40 undergoes a turning angle of 90 degrees between the open and locked states. By altering the dimensions of the curved surface 43 and the wedge plate 44, the turning angle is variable. FIGS. 3A and 3B show a latch with a turning angle of 180 degrees.

Referring to FIG. 4, in a second embodiment of the present invention, a helical spring 70 is inserted into said circular depression 41a of said latch 40. After the chain hook 60 having entered the groove 14 of the hook seat 11, the spring 70 stably holds the latch 40.

Referring to FIG. 5, in a third embodiment of the present invention, the latch 40 has a positioning device 401 for positioning of the latch 40 in several steps. The positioning device 401 comprises several depressions 35 on a peripheral outer surface of the tubelet 31 of the connecting device 30, a tunnel 45 on the curved surface 43, which is connected with the central hole 41, a steel ball 46, a spring 47, and a threaded worm 48. The steel ball 46 and the spring 47 are inserted into the tunnel 45 and held there by the threaded worm 48. The steel ball 46 is pressed against the peripheral surface of the tubelet 31. Turning of the latch 40 causes the steel ball 46 to wander around the tubelet 31, stably remaining in the depressions 35 thereof at certain angular positions of the latch 40, thus providing angular positioning of the latch 40.

Referring to FIG. 6, in a fourth embodiment of the present invention, the handle 42 has a handle grip 49 that perpendicularly extends away. In the open state, the handle grip 49 is oriented perpendicular to an opening direction of the doorplate 10, allowing to open the doorplate 10 by pushing the handle grip 49.

The main characteristic of the present invention, as compared to conventional art, lies in that upon closing the door, the latch at the curved surface and wedge plate thereof quickly and precisely pushes the hook into the hook seat, keeping the hook in a tight position, thus achieving maximum resistant against various kinds of blasts.

While the invention has been described with reference to preferred embodiments thereof, it is to be understood that modifications or variations may be easily made without departing from the spirit of this invention which is defined by the appended claims.

### BRIEF DESCRIPTION OF THE DRAWINGS

FIG. 1 is a perspective view of the latch apparatus of the present invention when disassembled.

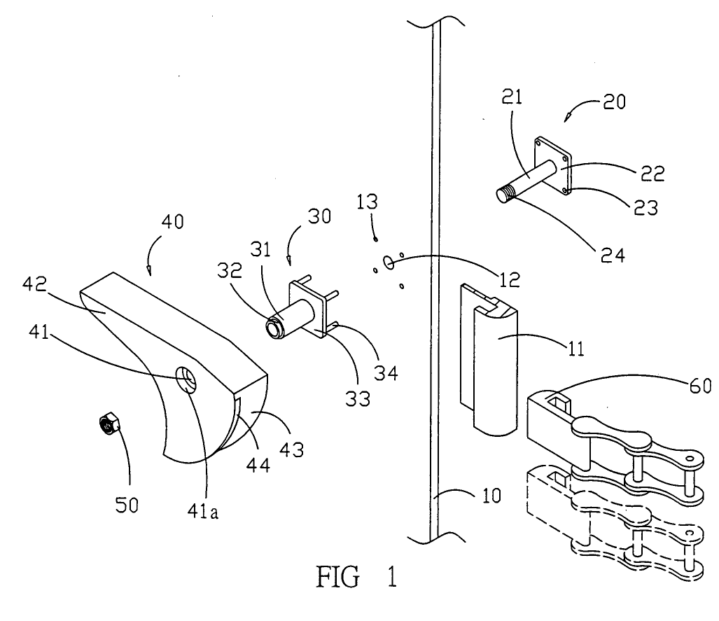

FIGS. 2A-2E are schematic views of the latch apparatus of the present invention with the hook seat and the chain hook disengaged or engaged.

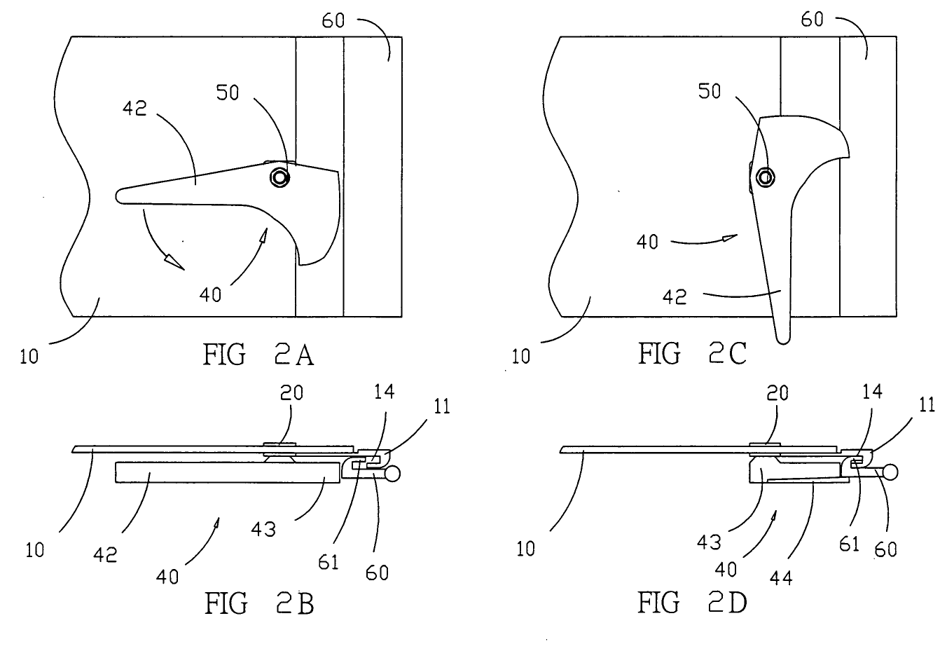

FIGS. 3A and 3B are perspective views of the latch of the present invention designed for a turning angle of 180 degrees.

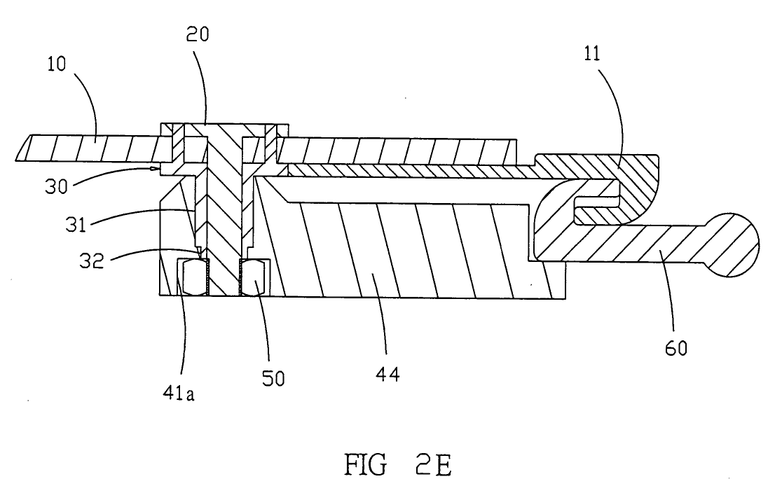

FIG. 4 is a perspective view of the latch apparatus of the present invention in the second embodiment when disassembled.

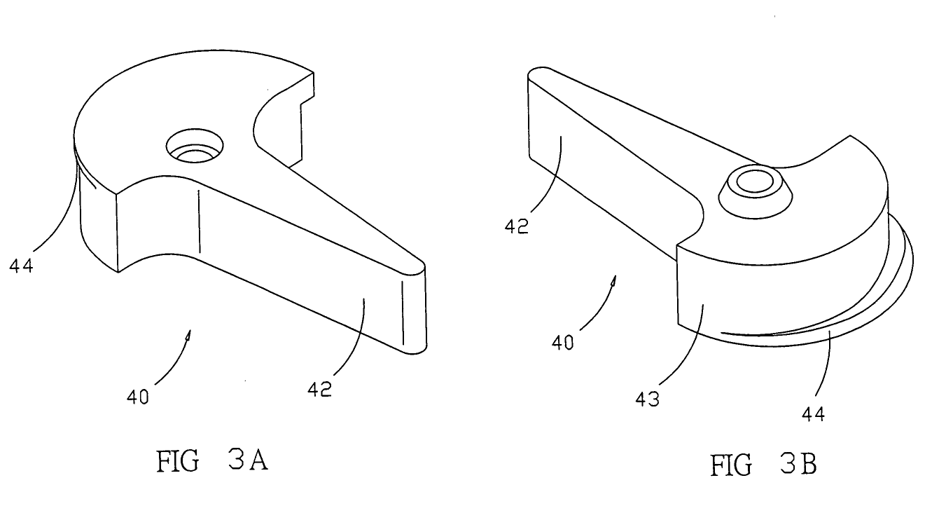

FIG. 5 is a perspective view of the latch apparatus of the present invention in the third embodiment when disassembled.

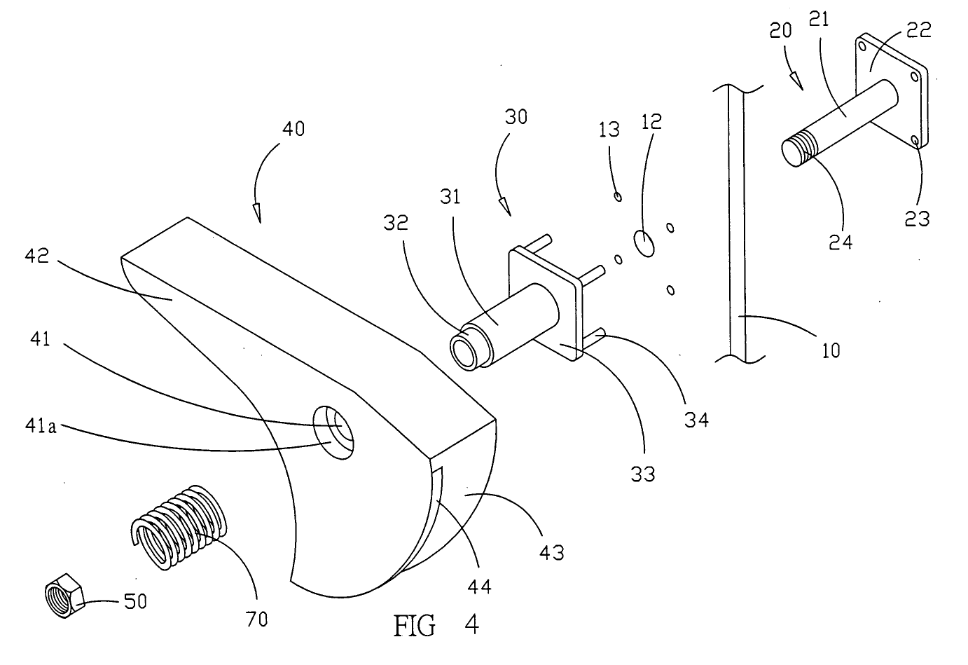

FIG. 6 is a perspective view of the latch of the present invention in the fourth embodiment.

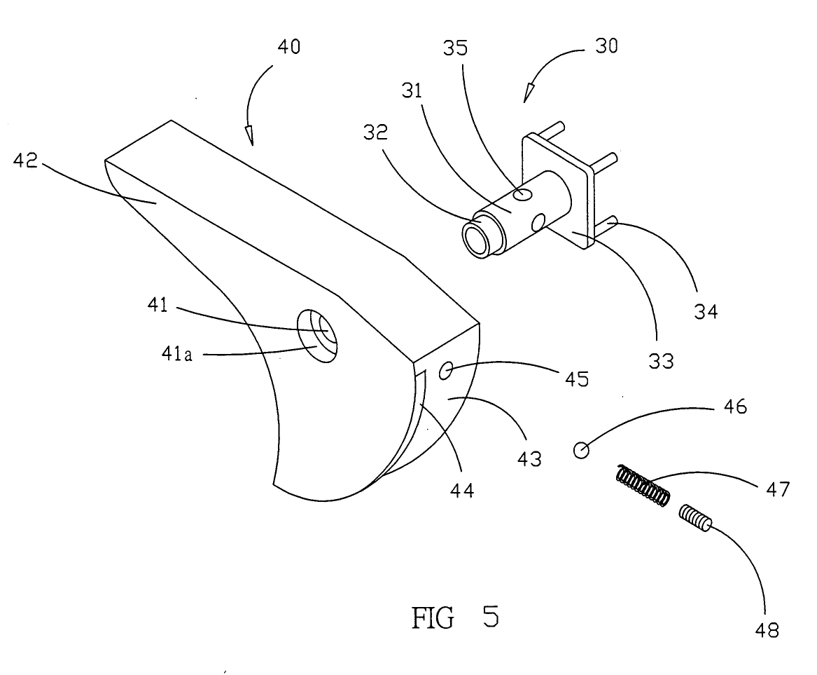

FIG. 7 (prior art) is a side view of a conventional blast-resistant container structure.

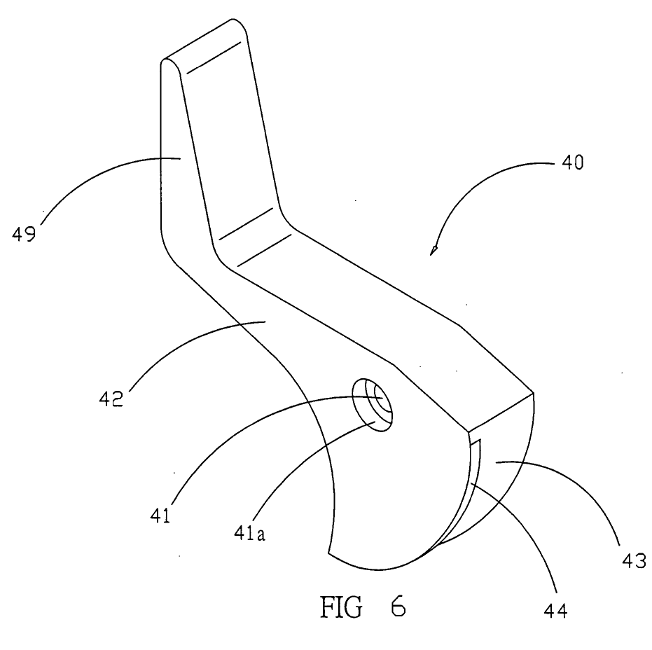

FIG. 8 (prior art) is a perspective view of a chain hook engaged with a hook seat of a conventional latch apparatus.

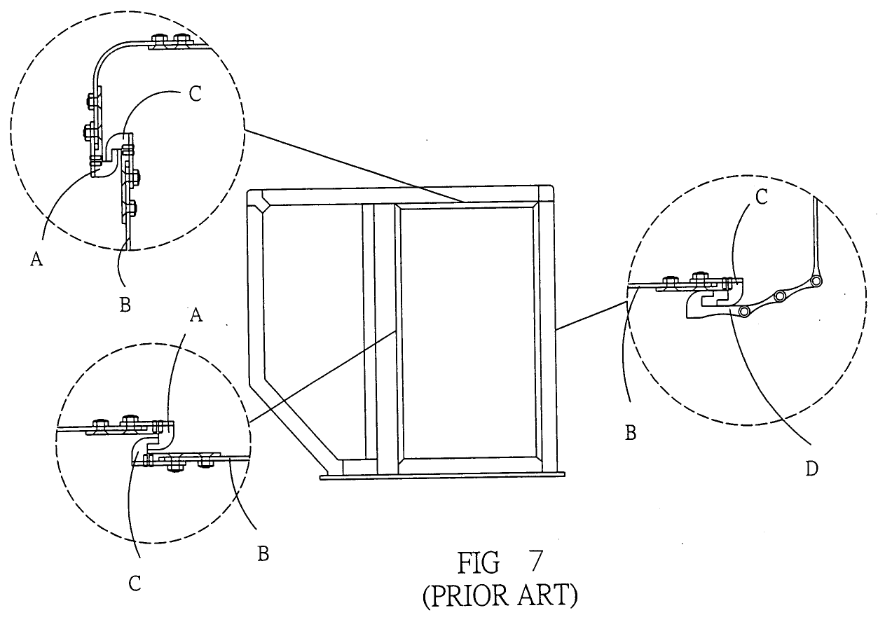

FIG. 9 (prior art) is a side view of another conventional latch apparatus.

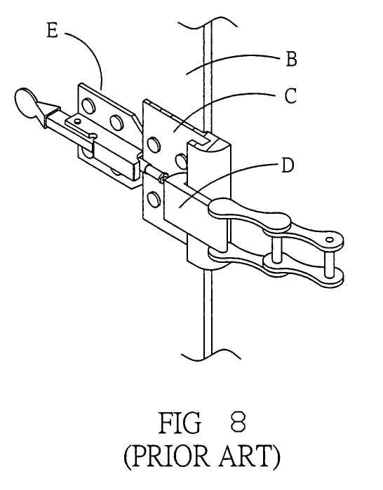

FIG. 10 (prior art) is a side view of a further conventional latch apparatus.

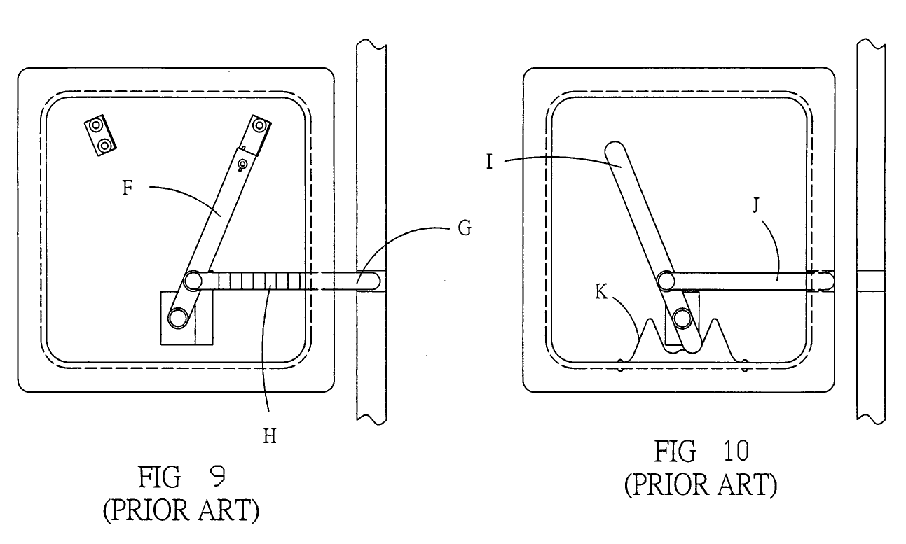

FIG. 11 (prior art) is a schematic illustration of lever arms resulting from the hook seat engaging with the hook of a conventional latch apparatus.

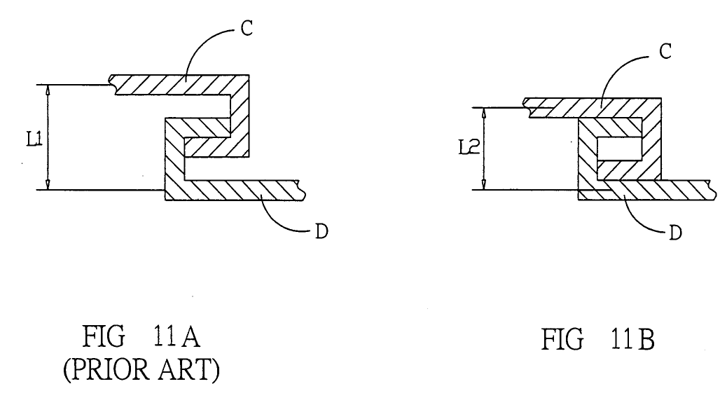

1. A latch apparatus for a blast-resistant container, comprising:
a chain hook, fastened to an edge of said blast-resistant container;
a door plate for closing said blast-resistant container, with a hook seat being attached close to an edge thereof and a through hole being bored through said door plate close to said hook seat;
a base, having a base plate on a rear side of said door plate and an axis attached to said base plate which passes through said through hole and has a far end on said front side of said door plate into which a thread is cut;
a connecting piece, having a rear plate and a tubelet attached to said rear plate, with said tubelet put over said axis on said far end thereof, so that said rear plate leans against said front side of said door plate;
a latch, having a central hole put over said tubelet, a handle that laterally extends away and, opposite to said handle, a curved surface and a front plate with a wedge-shaped cross-section attached to a front side; and
a nut, engaging with said thread of said axis, fastening said latch.

2. The latch apparatus for a blast-resistant container according to claim 1, wherein said rear plate of said connecting piece has several pins for angular fixing of connecting piece.

3. The latch apparatus for a blast-resistant container according to claim 1, wherein said base plate of said base has several positioning holes.

4. The latch apparatus for a blast-resistant container according to claim 1, wherein a spring is inserted in said central hole.

5. The latch apparatus for a blast-resistant container according to claim 1, wherein a positioning device is inserted between connecting piece and latch.

6. The latch apparatus for a blast-resistant container according to claim 5, wherein said positioning device comprises several depressions on a peripheral surface of said tubelet and a tunnel leading from said curved surface of said latch towards said tubelet, with a steel ball, a spring and a threaded worm being inserted into said tunnel, so that upon turning said latch around said tubelet said steel ball engages with one of said depressions in certain angular positions of said latch.

7. The latch apparatus for a blast-resistant container according to claim 1, wherein said handle has a handle grip that perpendicularly extends away.

8. The latch apparatus for a blast-resistant container according to claim 1, wherein said latch has a turning angle of 60-180 degrees between an open and a locked state.
